(19) United States
(12) Patent Application Publication
(10) Pub. No.: US 2005/0089000 A1
(43) Pub. Date: Apr. 28, 2005

(54) Method for communicating effectively between devices on wireless personal area network

(75) Inventors: Dae-gyu Bae, Suwon-si (KR); Jin-woo Hong, Seoul (KR); Hyun-ah Sung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/927,640

(22) Filed: Aug. 27, 2004

(30) Foreign Application Priority Data
Oct. 28, 2003 (KR) 10-2003-0075644

(51) Int. Cl. H04Q 7/24; H04J 3/24; H04L 12/28; H04L 12/56

(52) U.S. Cl. 370/338; 370/349

(57) ABSTRACT

A method for communicating effectively between devices on a wireless personal area network (PAN) within an allocated channel time, includes (a) filling a MAC frame with body frame(s) including upper layer data of a MAC layer to be transmitted such that no empty space remains in the MAC frame, (b) recording fragment information in each body frame, wherein the fragment information indicates whether the body frame is the last complete frame or has a remaining fragmented frame, and (c) extracting the upper layer data from the body frame existing in the transmitted MAC frame and transmitting the extracted upper layer data to the upper layer based on the fragment information.

### BACKGROUND OF THE INVENTION

This application claims priority of Korean Patent Application No. 10-2003-0075644 filed on Oct. 28, 2003 in the Korean Intellectual Property Office, the disclosure of which is incorporated herein in its entirety by reference.

1. Field of the Invention

A method consistent with the present invention relates to a method for communicating effectively between devices on a wireless network, and more particularly, to a method capable of increasing throughput, independent of the size of data received from an upper layer of a MAC (media access control) layer, by improving the MAC of the devices operating on a wireless PAN (Personal Area Network).

2. Description of the Related Art

UWB (Ultra Wideband), which is also known as wireless digital pulse, has been developed by the U.S. Department of Defense for military purposes, and is a radio technology for transmitting a great quantity of digital data through a wide spectrum frequency with low power across a short distance. UWB Standardization is now being done by a Working Group that establishes the IEEE 802.15.3 standards, i.e., the wireless PAN standards. The IEEE 802.15.3 standards deal with the PHY (physical layer) and the MAC layer. Recently, studies for improving MAC have been vigorously made in the field of radio technology.

In 802.15.3, MAC is characterized in that the establishment of a wireless network can be rapidly made. Further, this network establishment is not based on an AP (Access Point) but is rather an Ad Hoc Network called a Piconet with priority given to a PNC (Piconet Coordinator). The 802.15.3 MAC adopts a TDMA (Time Division Multiple Access) system. A MAC frame for exchanging data between devices is disposed in a temporal structure called a super frame as shown in FIG. 1. The super frame is composed of a beacon containing control information, a CAP (Contention Access Period) for transmitting data through backoff, and a CTAP (Channel Time Allocation Period) for transmitting data without contention within an allocated time. Among these components, the CAP can be replaced by MCTA (Management Channel Time Allocation). At this time, competitive access can be made in the CAP through a CSMA/CA (Carrier Sense Multiple Access/Collision Avoidance) system and a channel can be accessed in the MCTA through a slotted ALOHA technique.

The CTAP can comprise a plurality of MCTA blocks and a plurality of CTA (Channel Time Allocation) blocks. CTA is classified into two types, i.e., dynamic CTA and pseudo static CTA. The dynamic CTA can be changed in its position in each super frame, and cannot be used in a relevant super frame if the beacon of a super frame is lost. On the other hand, the pseudo static CTA remains unchanged in the same fixed position, and can be used in the fixed position even if the beacon of a super frame is lost. However, the pseudo static CTA cannot be used if a beacon is continuously lost over a number of times corresponding to mMaxLostBeacons. In this way, since the 802.15.3 MAC is based on the TDMA system, which is capable of ensuring QoS (Quality of Service), it is particularly suitable for multimedia audio/video (A/V) streaming on a home network.

However, according to the conventional IEEE 802.15.3 MAC, current MPDUs (MAC Protocol Data Units) are transmitted, including data received from a FCSL (Frame Conversion Sub Layer), one by one. Further, if the received data are not fragmented, the data receiving side transmits the data to a high-level FCSL as they are. In such a case, however, when the size of data to be transmitted is smaller than the maximum size of the MPDUs, an empty space remains, even if a payload portion of an MPDU is filled with the data. Therefore, it can be deemed that conventional IEEE 802.15.3 MAC is not suitable for ensuring maximum throughput, although it is suitable for ensuring QoS.

The configuration of the aforementioned conventional technique includes a PNC for allocating channel time to exchange data between devices while ensuring QoS, a source device for performing streaming operations during the allocated channel time, and a destination device for receiving the data streamed during the allocated channel time.

The operation of the conventional technique so configured will be discussed as follows. Initially, when first and second devices are powered on, they search respective relevant frequency bands, i.e., relevant channels, for respective PNCs. When the PNCs are found, a process for association with the PNCs is performed. Next, each of the first and second devices receives information on devices already associated with the piconet from their own associated PNCs.

If the first device intends to transmit real-time data to the second device, the first device transmits a command requesting channel time to the PNC, i.e., a channel time request command frame, so as to receive the required time allocated from the PNC. The PNC allocates, to the first device, the channel time during which the first device and the second device can communicate with each other, if there exists a resource of a wireless medium, i.e., a time slot, which can grant the current request of the first device.

The first device to which the channel time is allocated begins to transmit a MAC data frame to the second device when the channel time arrives. Thereafter, even while the data frame is being transmitted, the data transmission is paused if the channel time ends. Then, when the next channel time allocated to the first device arrives, the data transmission resumes.

On the other hand, the second device recognizes itself as a destination device by receiving a beacon frame from the PNC and listens during the relevant channel time. When the MAC data frame arrives from the first device, the second device decapsulates the MAC header and then sends only the MAC frame body up to an upper layer.

The existing MAC frame is composed of a MAC header and a MAC frame body. When the size of the frame (hereinafter, referred to as an “upper layer frame” or “upper layer data”) that a transmitting device has received from an upper layer of the MAC layer, i.e., the FCSL, is smaller than the maximum size of the MAC frame body, the upper layer frame is transmitted with the upper layer frame loaded in the MAC frame body. In this way, when data of a size smaller than the maximum size of the MAC frame body are transmitted in a MAC layer, bandwidth supported in the MAC layer cannot be utilized to the utmost. Accordingly, overall throughput is reduced.

### SUMMARY OF THE INVENTION

Illustrative embodiments of the present invention may solve the aforementioned problems, but are not required to do so. An exemplary object of the present invention is to provide a method for improving throughput by improving the structure of a MPDU (MAC Protocol Data Unit) defined in the IEEE 802.15.3 standards. To this end, a method consistent with the present invention allows data throughput to be maximized independently of the size of the data received from an upper layer by maximizing the amount of transmission data within a single frame using a new MAC frame structure.

Another exemplary object of the present invention aims to maintain a network where a method of the present invention is compatible with the conventional IEEE 802.15.3 MAC frame exchange methods.

According to an illustrative aspect of the present invention for achieving the above exemplary objects, there is provided a method for communicating effectively between devices on a wireless personal area network (PAN) within an allocated channel time, comprising the steps of (a) filling a MAC frame with at least one body frame including upper layer data of a MAC layer to be transmitted such that no empty space remains in the MAC frame, (b) recording fragment information in the body frame, wherein the fragment information indicates whether the body frame is the last complete frame or has a remaining fragmented frame, and (c) extracting the upper layer data from the body frame existing in the transmitted MAC frame and transmitting the extracted upper layer data to the upper layer based on the fragment information.

Preferably, but not necessarily, in order to fill the MAC frame such that no empty space remains therein, if a space remaining in the MAC frame after at least one body frame has been filled in the MAC frame in a given order is insufficient to be filled with the next body frame, the next MAC frame is filled with a next body frame.

Preferably, but not necessarily, in order to fill the MAC frame such that no empty space remains therein, if a space remaining in the MAC frame after at least one body frame has been filled in the MAC frame in a given order is insufficient to be filled with the next body frame, the next body frame is cut to correspond to the size of the remaining space, a cut portion of the next body frame is filled in the MAC frame, and a remaining cut portion of the next body frame is filled in the next MAC frame.

Further, the body frame may comprise (a) fragment information indicating whether the body frame is the last frame or has a remaining fragmented frame, (b) information on the size of the upper layer data existing in a payload of the body frame, and (c) the payload of the body frame into which the upper layer data are recorded.

Furthermore, the step of extracting the upper layer data may comprise the step of storing the body frame in a buffer, if the fragment information of the body frame indicates that a remaining fragmented frame exists.

In addition, the step of extracting the upper layer data may comprise the steps of (a) reading fragment information of a previous body frame existing before the current body frame, if the fragment information of the current body frame corresponds to a value indicating the last frame; (b) removing a header of the current body frame, if the fragment information of the previous body frame corresponds to a value indicating the last frame; and (c) removing headers of the previous and current body frames and then defragmenting both the previous and current body frames, if the fragment information of the previous body frame corresponds to a value indicating that a remaining fragmented frame exists.

### BRIEF DESCRIPTION OF THE DRAWINGS

The above and other exemplary objects, features and advantages of the present invention will become apparent from the following description of an illustrative, non-limiting embodiment given in conjunction with the accompanying drawings, in which:

FIG. 1 is a view showing the structure of a related art super frame of the IEEE 802.15.3;

FIG. 2 is a view showing the structure of an association request command frame according to the present invention;

FIG. 3 is a view showing the structure of a channel time request command frame according to the present invention;

FIG. 4 is a view showing the structure of a channel time response command frame according to the present invention;

FIG. 5 is a view showing the structure of a MAC data frame according to the present invention;

FIG. 6 is a view showing the structure of a MAC header according to the present invention;

FIG. 7A shows an example of upper layer data to be transmitted;

FIG. 7B is a view showing a transport scheme when the transport mode in FIG. 7A is ‘TRANSPORT_MODE_NOPACK’;

FIG. 7C is a view showing a transport scheme when the transport mode in FIG. 7A is ‘TRANSPORT_MODE_PACK’;

FIG. 7D is a view showing a transport scheme when the transport mode in FIG. 7A is ‘TRANSPORT_MODE_PACK_FULL’;

FIG. 8A is a flowchart illustrating a setup process for exchanging data between devices;

FIG. 8B is a flowchart illustrating the operation of transmitting data by a transmitting device, following the setup process of FIG. 8A; and

FIG. 8C is a flowchart illustrating the operation of receiving the data, which was transmitted in the operation of FIG. 8B, by a receiving device.

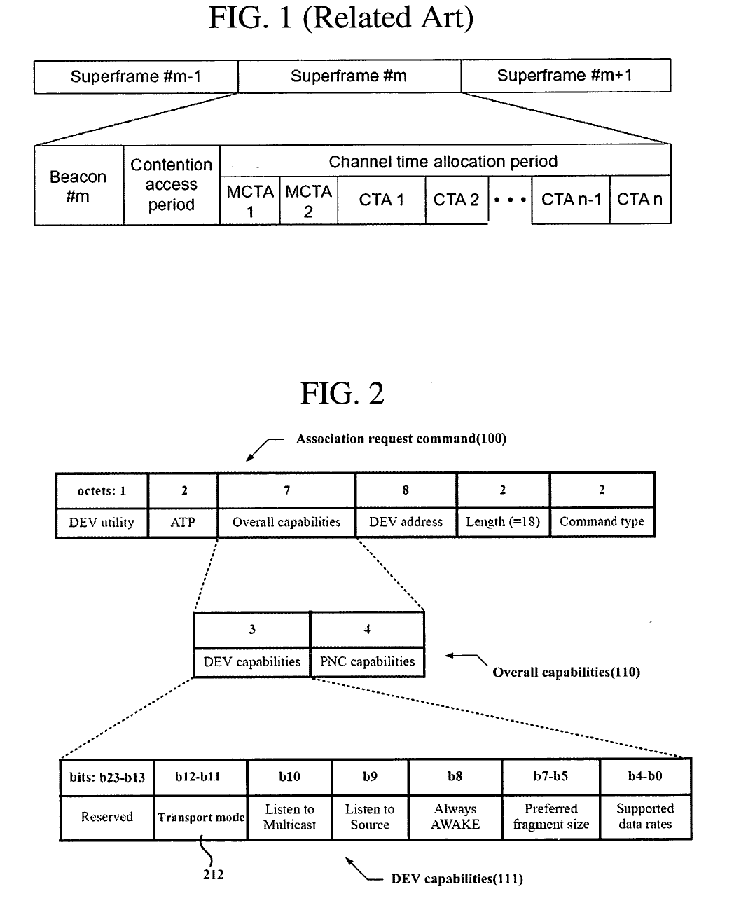

### DETAILED DESCRIPTION OF THE INVENTION

Hereinafter, an illustrative, non-limiting embodiment of the present invention will be described in detail with reference to the accompanying drawings.

FIG. 2 is a view showing the structure of an association request command frame 100 according to the present invention. When a first device to transmit data and a second device to receive data are powered on, each device first searches for a PNC in a relevant channel and then transmits an association request command frame 100 to the PNC in order to associate with the PNC. Thus, each device can transfer its own device characteristics to the associated PNC.

At this time, a variety of functions of the devices are recorded in lower fields of a DEV capabilities field 111 of an overall capabilities field 110 in the association request command frame 100. These functions include supported data rates, preferred fragment sizes, ‘Always AWAKE’, ‘Listen to Source’, ‘Listen to Multicast’, and the like. In the present invention, a field 212 called ‘Transport mode’ is defined using 2 bits of a reserved field, in addition to these conventional fields. This ‘Transport mode’ field 212 can have the values of ‘00’, ‘01’ and ‘10’, while the value of ‘11’ is reserved. The value ‘00’ means ‘TRANSPORT_MODE_NOPACK’, the value ‘01’ means ‘TRANSPORT_MODE_PACK’, and the value ‘10’ means ‘TRANSPORT_MODE_PACK_FULL’.

The ‘TRANSPORT_MODE_NOPACK’ is a conventional scheme used in the existing 802.15.3 and means that only a single upper layer frame can be loaded into the frame body of a MAC data frame. The ‘TRANSPORT_MODE_PACK’ means that a plurality of upper layer frames can be packed together into the body frame of the MAC data frame so that they can be transferred together, but the upper layer frames are not cut. Further, the ‘TRANSPORT_MODE_PACK_FULL’ means that the body frame is filled with a plurality of the upper layer frames to the utmost, and the upper layer frames can be cut and divided if necessary. That is, when a specific upper layer frame to be filled into the end portion of the body frame is larger than the end portion, the specific upper layer frame is cut to correspond to the empty space of the body frame and the cut upper layer frame is filled into the empty space. Then, a remaining portion of the cut upper layer frame is filled into the next MAC data frame when the next frame is transmitted.

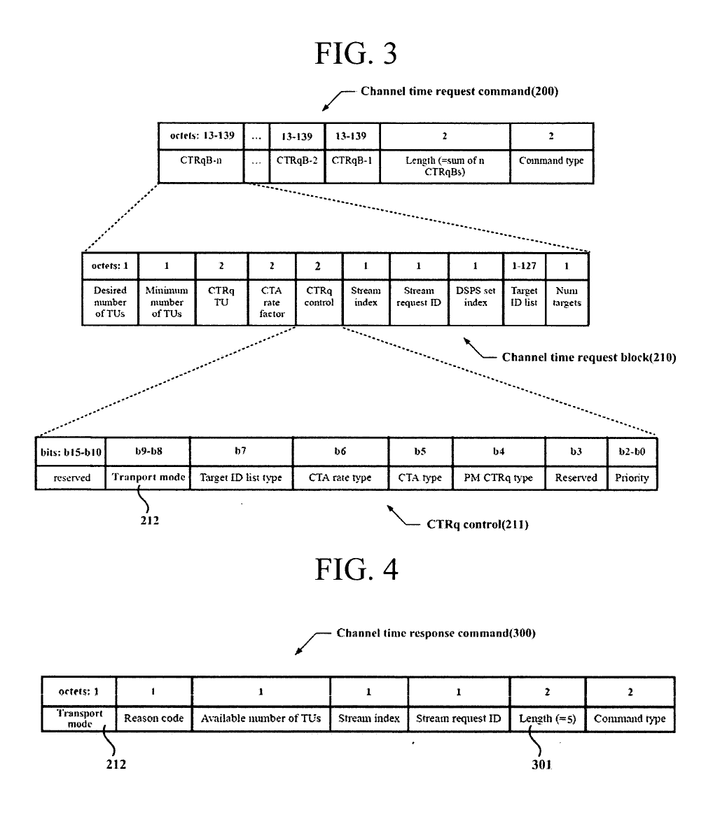

FIG. 3 is a view showing the structure of a channel time request command frame 200 according to the present invention. When the first device intends to send data to the second device, the first device sends the PNC a command requesting a channel time, i.e., a channel time request command frame 200, so as to receive the required time allocated from the PNC. The channel time request command frame 200 is composed of a ‘Command type’ field indicating the types of command frames, a ‘Length’ field indicating the length of data, i.e., a total sum of sizes of the overall number of octets occupied by at least one CTRqB (Channel Time Request Block), and at least one channel time request block 210 containing the request for channel time from the PNC. Each of the channel time request blocks 210 includes a variety of fields ranging from a ‘Num targets’ field to a ‘Desired number of TUs’ field. Among the fields, a ‘CTRq control’ field 211 contains a variety of control information on the channel time request. The ‘CTRq control’ field 211 also includes sub-fields such as ‘Priority’, ‘PM CTRq type’, ‘CTA type’, ‘CTA rate type’, ‘Target ID list type’ and the like. In the present invention, a ‘Transport mode’ field 212 is added to the ‘CTRq control’ field using 2 bits of the reserved field, in addition to such conventional sub-fields. The values and meanings of the ‘Transport mode’ field 212 are the same as those described in FIG. 2.

FIG. 4 is a view showing the structure of a channel time response command frame 300 according to the present invention. In both a case where the PNC allocates channel time to a device requesting the channel time and a case where no allocation is made due to a shortage of resources, results of the channel time allocation request are reported to the requesting device using the channel time response command frame 300. In the channel time response command frame 300, a ‘Transport mode’ field is also added to the conventional fields ranging from the ‘Command type’ field to the ‘Reason code’ field. Since no reserved field exists in the frame 300, one additional octet is used to record the transport mode (for example, 2 bits thereof are used and the remaining bits are reserved). Accordingly, contrary to a conventional channel time response command frame, the value of the ‘Length’ field 301 is not ‘4’ but ‘5’.

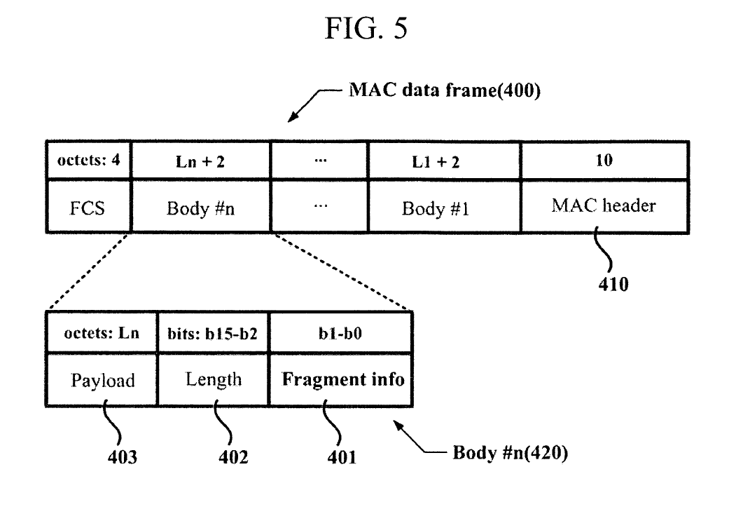

FIG. 5 is a view showing the structure of a MAC data frame 400 according to the present invention. As shown in FIG. 5, when the MAC frame 400 is in the form of a data frame, a portion other than a MAC header 410 comprises one or more independent body frames 420. Each of the body frames includes a header of the body frame, i.e., a body header 401, 402 and a payload 403 of the body frame. Further, the body header includes a ‘Fragment info’ field 401 for recording fragment information of the body frame and a ‘Length’ field 402 for recording the size of the payload. In addition, the payload 403 contains actual upper layer data.

The length of payload for each body frame is determined according to the size of the upper layer data and may vary for each payload. The size of each body frame becomes the total sum of the size of the payload and the sizes of the ‘Length’ and ‘Fragment info’ fields. Accordingly, the size of the body frame 420 designated ‘Body #n’ becomes Ln+2 in octets, which corresponds to a value obtained by adding two (2) to the payload size, Ln.

The ‘Fragment info’ field 401 can have the values of ‘00’, ‘01’ and ‘10’, and the value ‘11’ is reserved. The values of ‘00’, ‘01’ and ‘10’ mean ‘NO_MORE_DATA’, ‘COMPLETE_FRAME’ and ‘FRAGMENTED_FRAME’, respectively. ‘COMPLETE_FRAME’ means that the current body frame included in the MAC data frame is either the last frame of a plurality of fragmented body frames or one complete body frame. Conversely, ‘FRAGMENTED_FRAME’ means that the current body frame included in the MAC data frame is not the last frame of a plurality of fragmented body frames. Further, ‘NO_MORE_DATA’ means that there is no need to wait to receive the next body frame in the current MAC data frame 400 because a new body frame does not exist after the current body frame. Finally, ‘NO_MORE_DATA’ or ‘COMPLETE_FRAME’ means that the current body frame is the last frame, whereas ‘FRAGMENTED_FRAME’ means that there are other fragmented frames in addition to the current body frame.

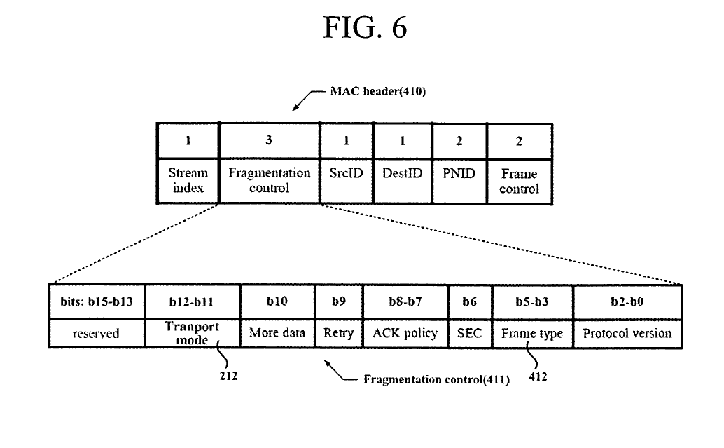

When the first device transmits the MAC frame, the second device that receives the MAC frame first determines whether a ‘Frame type’ field 412 existing in a ‘Fragmentation control’ field 411 of the MAC header 410 has a value indicating a data frame, as shown in FIG. 6. If it is determined that the transmitted MAC frame is a data frame, the data frame is interpreted with reference to a ‘Transport mode’ field 212 existing in the ‘Fragmentation control’ field 411. The values and meanings of the ‘Transport mode’ field 212 are the same as those described in FIG. 2.

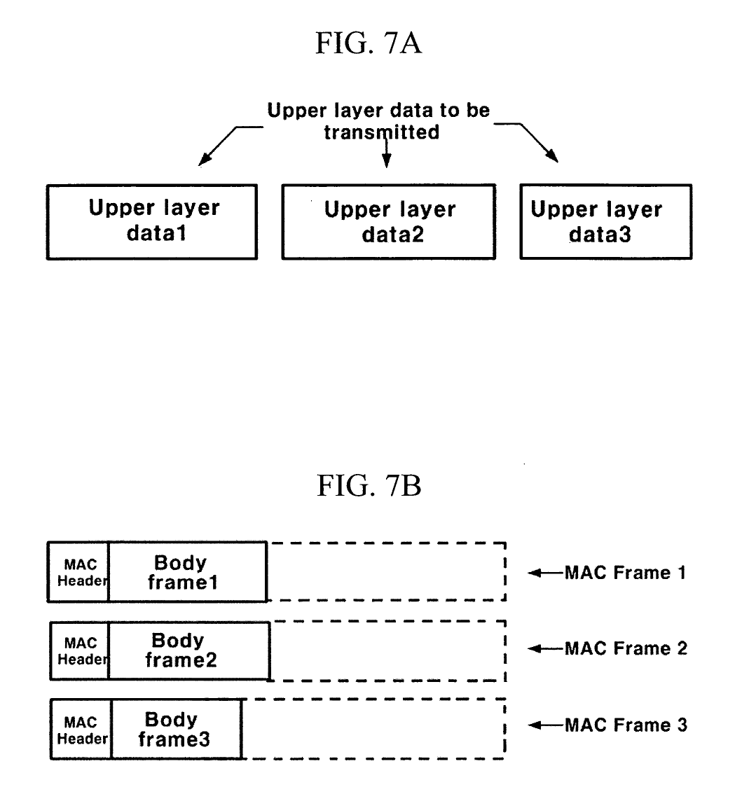

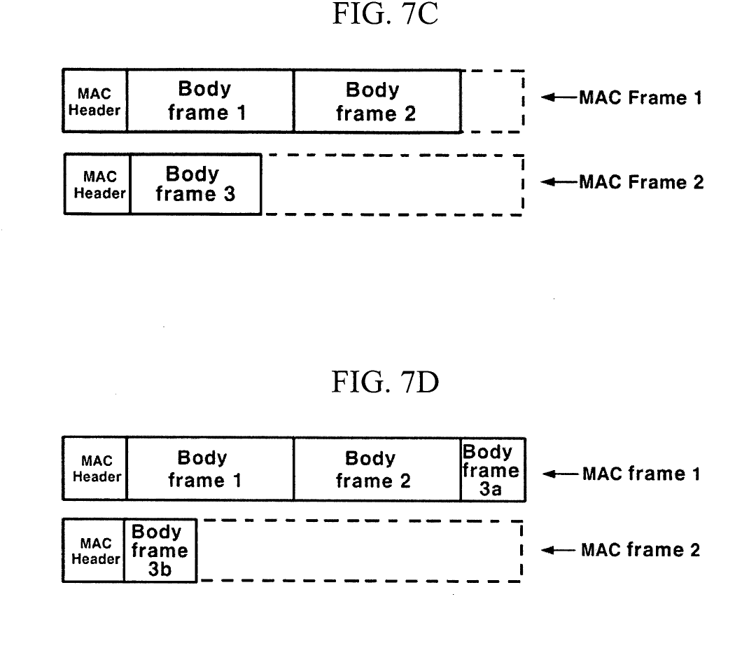

FIGS. 7B and 7D show examples of transmitting data using the MAC frame according to the respective transport modes. A ‘TRANSPORT_MODE_NOPACK’ mode is the same as that in the conventional IEEE 802.15.3 scheme. Namely, only a single body frame for the upper layer data enters the payload portion of the MAC frame. Since the payload portion of the MAC frame may be composed of different body frames in a ‘TRANSPORT_MODE_PACK’ mode or a ‘TRANSPORT_MODE_PACK_FULL’ mode as described above, the following interpretation is made at the receiving side.

Operation in each mode will be hereinafter described with reference to FIGS. 7B to 7D, on the assumption that there are data which will be received from an upper layer, i.e., FCSL, and then transmitted in a MAC layer as shown in FIG. 7A. Portions shown in dotted lines in these figures indicate the maximum size of the MAC frame. Each of the upper layer data is loaded into the MAC frame after a body frame has been formed by attaching a body header thereto. First upper layer data become a first body frame after a body header has been attached thereto. A similar procedure is also applied to the other upper layer data. If it is assumed that the size of a receiving device can support the maximum size of the transmitted MAC frame, the operation thereof will vary for each mode as shown in FIGS. 7B to 7D.

When the transport mode is the ‘TRANSPORT_MODE_NOPACK’ mode as shown in FIG. 7B, its transport scheme is the same as that in the conventional IEEE 802.15.3. Accordingly, when a body frame smaller than the maximum size of the MAC frame is loaded, a great deal of empty space still remains in the MAC frame as shown in FIG. 7B.

When the transport mode is the ‘TRANSPORT_MODE_PACK’ mode as shown in FIG. 7C, the MAC frame is filled with the body frames as full as possible. However, if the remaining space of the MAC frame is smaller than a body frame to be currently filled therein, the body frame is no longer filled into the remaining space of the MAC frame. In this way, in the case of the ‘TRANSPORT_MODE_PACK’ mode, the body frame to be currently filled is not cut. Thus, the third body frame (i.e., Body frame 3) is included in the next MAC frame (i.e., MAC Frame 2) when the next MAC frame is transported. Here, ‘fragment info’ fields of the first and second body frames (i.e., Body frame 1 and Body frame 2) become ‘01’ indicating that they are complete last frames, and a ‘fragment info’ field of the third body frame becomes ‘00’ indicating that there is no further data.

When the transport mode is the ‘TRANSPORT_MODE_PACK_FULL’ mode as shown in FIG. 7D, the first and second body frames (i.e., Body frame 1 and Body frame 2) are loaded in the manner as shown in FIG. 7C. Additionally, an empty space of the first MAC frame (i.e., MAC frame 1) is filled with only Body frame 3a corresponding to part of the third body frame, while Body frame 3b corresponding to the other part of the third body frame is included in the next MAC frame (i.e., MAC frame 2) when the next MAC frame is transported. In this case, the second MAC frame has more empty space as shown in FIG. 7D than in FIG. 7C, but the first MAC frame has no empty space as shown in FIG. 7D, unlike in FIG. 7C. Here, ‘fragment info’ fields of the first and second body frames become ‘01’ indicating that they are complete last frames. A ‘fragment info’ field of the Body frame 3a becomes ‘10’ indicating that it is an incomplete frame, and a ‘fragment info’ field of the Body frame 3b becomes ‘00’ indicating that there is no further data.

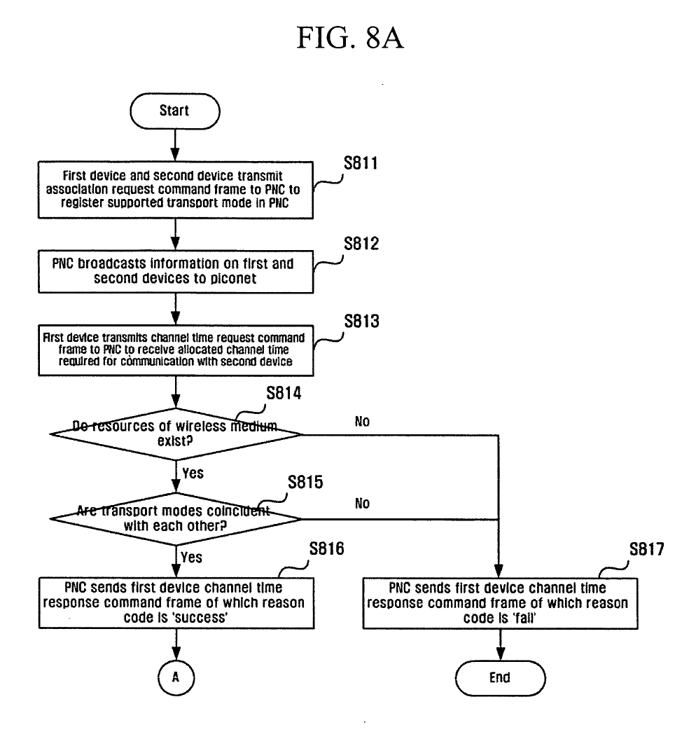

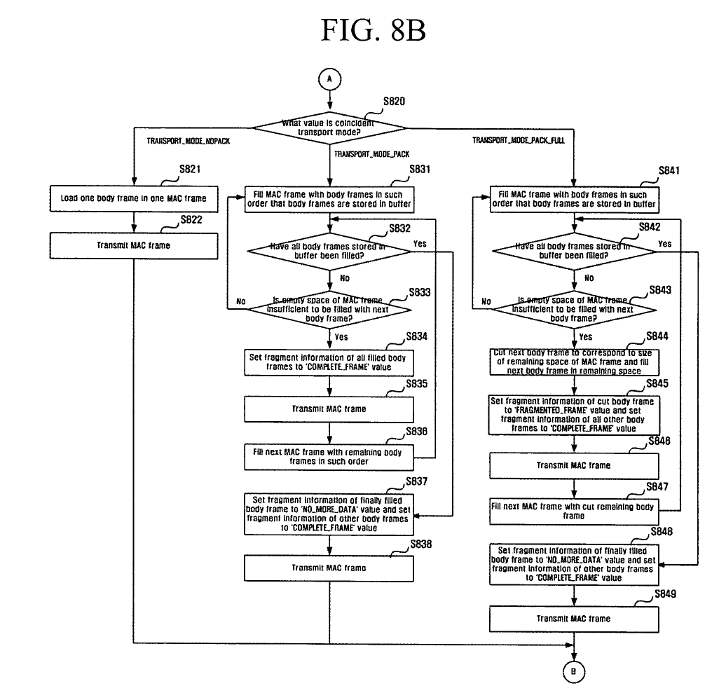

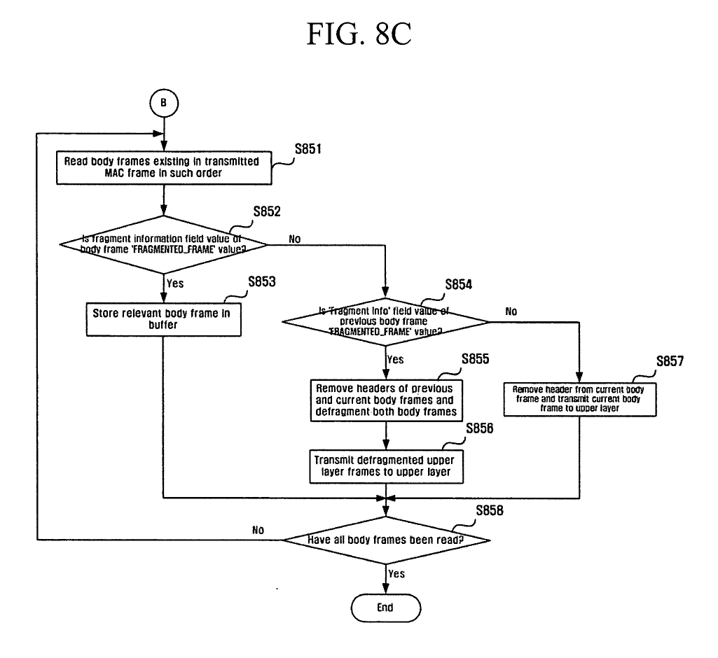

FIGS. 8A to 8C are flowcharts illustrating the overall operation of the present invention. In particular, FIG. 8A shows a flowchart illustrating a setup process of exchanging data between first and second devices.

First, the first and second devices transmit an association request command frame to a PNC, and register a frame transmission/reception mode supportable by themselves, i.e. a transport mode, into the PNC (S811). Then, the PNC broadcasts information on the first and second devices to the other devices existing on a piconet (S812).

The first device determines the transport mode of a frame in which it can communicate with the second device in a MAC layer, and then transmits a channel time request command frame to the PNC so that a required channel time can be allocated to itself (S813). The PNC transmits a channel time response command frame to the first device so as to inform the first device whether the requested channel time has been allocated (S816, S817). According to the conventional IEEE 802.15.3 standards, the PNC determines whether the channel time can be allocated by determining only resources of the wireless medium (S814). However, according to the present invention, it is also determined whether transport modes in which both devices intend to communicate with each other are coincident with each other (S815). If the resources exist and the transport modes of both devices are coincident with each other, the PNC sends the first device the channel time response command frame of which a reason code is ‘success’, in order to inform the first device that the channel time is properly allocated (S816). Otherwise, the PNC sends the first device the channel time response command frame of which a reason code is ‘fail’, in order to inform the first device that channel time is not properly allocated (S817).

FIG. 8B is a flowchart illustrating the operation for transmitting data by a transmitting side device, i.e., the first device, following the successful allocation of channel time during the setup process illustrated in FIG. 8A.

First, it is determined what value the coincident transport mode has (S820). If the mode corresponds to the ‘TRANSPORT_MODE_NOPACK’ value of ‘00’, one body frame is loaded into one MAC frame (S821) and the MAC frame is then transmitted (S822), because its transport scheme is the same as that in the conventional IEEE 802.15.3 standards.

If it is determined in step S820 that the transport mode is set to correspond to the ‘TRANSPORT_MODE_PACK’ value of ‘01’, the MAC frame is first filled with body frames in such an order that the body frames are stored in a frame buffer (S831). If all the body frames stored in the frame buffer are filled in the MAC frame (‘Yes’ in step S832), the process proceeds to step S837. Otherwise (‘No’ in step S832), it is determined whether the remaining space of the MAC frame is insufficient to be filled with the next body frame (S832). If it is sufficient (‘No’ in step S833), the process returns to step S831. If it is determined that the remaining space of the MAC frame is insufficient to be filled with next body frame (‘Yes’ in step S833), the ‘Fragment info’ fields of all the body frames already filled in the MAC frame are set to the ‘COMPLETE_FRAME’ value of ‘01’ (S834) and the relevant frame is then transmitted (S835). Then, the next MAC frame is again filled with the body frames remaining in the frame buffer in such an order (S836). If all the body frames stored in the frame buffer are still not filled (‘No’ in step S832), steps S831 to S836 are repeated. When all the body frames are filled (‘Yes’ in step S832), the process proceeds to step S837.

Next, the ‘Fragment info’ field of a finally filled body frame is set to the ‘NO_MORE_DATA’ value of ‘00’, and ‘Fragment info’ fields of the other body frames are set to the ‘COMPLETE_FRAME’ value of ‘01’ (S837). Then, the relevant MAC frame is transmitted (S838).

If it is determined in step S820 that the transport mode is set to the ‘TRANSPORT_MODE_PACK_FULL’ value of ‘10’, the MAC frame is first filled with the body frames in such an order that the body frames are stored in the frame buffer (S841). If all the body frames stored in the frame buffer are filled in the MAC frame (‘Yes’ in step S842), the process proceeds to step S848. Otherwise (‘No’ in step S842), it is determined whether the remaining space of the MAC frame is insufficient to be filled with the next body frame (S843). If it is sufficient (‘No’ in step S843), the process returns to step S841. If it is determined that the remaining space of the MAC frame is insufficient to be filled with the next body frame (‘Yes’ in step S843), the next body frame is cut to correspond to the size of the remaining space of the MAC frame and then the cut portion is filled in the remaining space (S844). Then, a ‘Fragment info’ field of the partially cut body frame is set to the ‘FRAGMENTED_FRAME’ value of ‘10’ and ‘Fragment info’ fields of all the other body frames are set to the ‘COMPLETE_FRAME’ value of ‘01’ (S845). The relevant frame is then transmitted (S846). Thereafter, the next MAC frame is filled with the remaining portion of the cut body frame (S847). If all the body frames stored in the frame buffer are not still filled (‘No’ in step S842), steps S841 to S847 are repeated. When all the body frames are filled (‘Yes’ in step S842), the process proceeds to step S848.

Next, the ‘Fragment info’ field of a finally filled body frame is set to the ‘NO_MORE_DATA’ value of ‘00’, and ‘Fragment info’ fields of the other body frames are set to the ‘COMPLETE_FRAME’ value of ‘01’ (S848). Then, the relevant MAC frame is transmitted (S849).

FIG. 8C shows a flowchart illustrating the operation for receiving the transmitted data by a receiving side device, i.e., the second device, following the process illustrated in FIG. 8B. The body frames existing in the MAC frame transmitted from the first device through the process illustrated in FIG. 8B are sequentially read (S851). It is determined whether the value of the ‘Fragment info’ field of the currently read body frame is the ‘FRAGMENTED_FRAME’ value of ‘10’ (S852). If so (‘Yes’ in step S852), the relevant body frame is stored in the frame buffer (S853). If it is determined in step S852 that the value of the ‘Fragment info’ field is either the ‘COMPLETE_FRAME’ value of ‘01’ or the ‘NO_MORE_DATA’ value of ‘00’ (‘No’ in step S852), it is then determined whether the value of the ‘Fragment info’ field of the previous body frame is the ‘FRAGMENTED_FRAME’ value of ‘10’ (S854). If the ‘Fragment info’ field value is not the ‘FRAGMENTED_FRAME’ value of ‘10’ (‘No’ in step S854), the MAC frame is a frame completed with the current body frame and accordingly transmitted to an upper layer after a header of the current body frame is removed (S857).

If it is determined in step S854 that the ‘Fragment info’ field value of the previous body frame is the ‘FRAGMENTED_FRAME’ value of ‘10’ (‘Yes’ in step S854), headers of the previous and current body frames are removed and both frames are then defragmented (S855). Then, the defragmented upper layer frames are transmitted to the upper layer (S856). Steps S851 to S857 are repeated until all the body frames received by the second device are read (‘Yes’ in step S858).

By way of example, an illustrative scheme consistent with the present invention is hereafter compared with the conventional scheme in view of their respective throughput.

It is assumed that the maximum size of data transmitted by a MAC frame is 2048 bytes and the data are transmitted at the rate of 54 Mbps except for effects of the physical layer on the transfer rate. It is also assumed that data received from the upper layer are always ready and the size of the data is 256 bytes. In a case where an IMM-ACK (immediate acknowledgement) policy is applied, when the length of the payload is L, the number of frames transmittable for one second (i.e., Fps) is expressed as the following Table 1, wherein H is the size of the MAC header and SIFS is the short interframe space.

TABLE 1

Fps = 1 sec/54 Mbps*(L + 2H)*8 + 2SIFS

If the expression of Table 1 is applied to the conventional scheme, a data transmission rate of 33.6 Mbps can be obtained when L is 256 bytes. On the other hand, if the above expression is applied to the ‘TRANSPORT_MODE_PACK_FULL’ mode of the present invention, a rate of 50.4 Mbps can be obtained. Here, if bytes of the MAC header and bytes of the body header are excluded from the maximum size of 2048 bytes and genuine data of 2022 bytes are then applied to the expression, a rate of 49.78 Mbps can be obtained. This results in a 48% improvement in performance over the conventional scheme. As can be seen from the expression of Table 1, the throughput of the conventional scheme is increased as the size of L becomes large. Thus, the illustrative scheme of the present invention is even more effective when the size of data received from the upper layer is small or variation in the size of the data is severe.

According to the present invention, maximum bandwidth supportable in a MAC layer can be supported by using new MAC data frames. Therefore, an improved transfer rate can be obtained and buffer overflow can also be reduced by minimizing a data buffering load.

According to the present invention, since an application of an upper layer can disregard variation in throughput, which can be produced by the size of MPDUs of the MAC layer and the number of frames to be transmitted, dependency of the application on the MAC layer can be lowered. In addition, since the MAC layer transmits data from the upper layer in a state where a MAC frame is filled with the data as full as possible, the number of ACK (acknowledgement) frames to be received and, thus, an amount of time spent waiting for the ACK frames is reduced. Furthermore, since a plurality of MAC frames share a MAC header, space occupied by the MAC header, in which data received from the upper layer cannot be loaded, can also be reduced.

The present invention has been described in connection with the illustrative embodiment set forth herein, and it will be apparent to those skilled in the art that various modifications and changes may be made thereto without departing from the scope and spirit of the invention. Therefore, it should be understood that the illustrative embodiment is not limitative or restrictive in any respect. The scope of the present invention is defined not by the detailed description but rather the appended claims. All modifications and changes, which may be derived from the scope and spirit of the claims and equivalents thereof, should be construed to be included in the scope of the present invention.

1. A method for communicating between a plurality of devices on a wireless personal area network (PAN) within an allocated channel time, comprising:
(a) filling a media access control (MAC) frame with at least one body frame including upper layer data to be transmitted to reduce an empty space remaining in the MAC frame;
(b) recording fragment information in each of the at least one body frame, wherein the fragment information indicates whether the body frame is a last complete frame or has a remaining fragmented body frame; and
(c) extracting the upper layer data from each of the at least one body frame existing in the transmitted MAC frame and transmitting the extracted upper layer data to the upper layer based on the fragment information.

2. The method as claimed in claim 1, wherein in order to fill the MAC frame to reduce the empty space remaining therein, if a space remaining in the MAC frame after the at least one body frame has been filled in the MAC frame in a given order is sufficient to be filled with a next body frame, the MAC frame is filled with the next body frame.

3. The method as claimed in claim 1, wherein if a space remaining in the MAC frame after the at least one body frame has been filled in the MAC frame in a given order is insufficient to be filled with a next body frame, the next MAC frame is filled with the next body frame.

4. The method as claimed in claim 1, wherein in order to fill the MAC frame so no empty space remains therein, if a space remaining in the MAC frame after the at least one body frame has been filled in the MAC frame in a given order is insufficient to be filled with a next body frame, the next body frame is cut into a first portion corresponding to a size of the remaining space and a remaining portion, the first portion of the next body frame is filled in the MAC frame, and a remaining portion of the next body frame is filled in the next MAC frame.

5. The method as claimed in claim 1, wherein each of the at least one body frame comprises the fragment information indicating whether the body frame is the last complete body frame or has the remaining fragmented body frame, information on a size of the upper layer data existing in a payload of the body frame, and the payload of the body frame in which the upper layer data are recorded.

6. The method as claimed in claim 1, wherein extracting the upper layer data comprises storing the body frame in a buffer, if the fragment information of the body frame indicates a remaining fragmented body frame.

7. The method as claimed in claim 1, wherein extracting the upper layer data comprises:
reading the fragment information of a previous body frame filled in the MAC frame before the current body frame, if the fragment information of the current body frame corresponds to a value indicating the last frame;
removing a header of the current body frame, if the fragment information of the previous body frame corresponds to a value indicating the last frame; and
removing headers of the previous and current body frames and then defragmenting the previous and current body frames, if the fragment information of the previous body frame corresponds to a value indicating a remaining fragmented body frame.
